(19) United States
(12) Patent Application Publication
(10) Pub. No.: US 2007/0165961 A1
(43) Pub. Date: Jul. 19, 2007

(54) Method And Apparatus For Reducing Motion Blur In An Image

(76) Inventor: Juwei Lu, Toronto (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/560,728

(22) Filed: Nov. 16, 2006

Related U.S. Application Data
(60) Provisional application No. 60/758,712, filed on Jan. 13, 2006.

(51) Int. Cl. G06K 9/40

(52) U.S. Cl. 382/254

(57) ABSTRACT

A method of reducing motion blur in a motion blurred image comprises blurring a guess image based on the motion blurred image as a function of blur parameters of the motion blurred image. The blurred guess image is compared with the motion blurred image and an error image is generated. The error image is blurred and a regularization image is formed based on edges in the guess image. The error image, the regularization image and the guess image are combined thereby to update the guess image and correct for motion blur. A method of generating a motion blur corrected image using multiple motion blurred images, each having respective blur parameters is also provided.

### CROSS-REFERENCE TO RELATED APPLICATION

This application claims the benefit under 35 U.S.C. 119(e) of U.S. Provisional Patent Application Ser. No. 60/758,712, filed on Jan. 13, 2006, the content of which is incorporated herein by reference.

### FIELD OF THE INVENTION

The present invention relates generally to image processing, and more particularly to a method and apparatus for reducing motion blur in an image.

### BACKGROUND OF THE INVENTION

Motion blur is a well-known problem in the imaging art that may occur during image capture using digital video or still-photo cameras. Motion blur is caused by camera motion, such as vibration, during the image capture process. Historically, motion blur could only be corrected when a priori measurements estimating actual camera motion were available. As will be appreciated, such a priori measurements typically were not available and as a result, other techniques were developed to correct for motion blur in captured images.

For example, methods for estimating camera motion parameters (i.e. the blur direction and blur extent) based on attributes intrinsic to a captured motion blurred image are disclosed in co-pending U.S. patent application Ser. No. 10/827,394 entitled, “MOTION BLUR CORRECTION”, assigned to the assignee of the present application, the content of which is incorporated herein by reference. In these methods, once the camera motion parameters are estimated, blur correction is conducted using the estimated camera motion parameters to reverse the effects of camera motion and thereby blur correct the image.

Methods for reversing the effects of camera motion to blur correct a motion blurred image are known. For example, the publication entitled “Iterative Methods for Image Deblurring” authored by Biemond et al. (Proceedings of the IEEE, Vol. 78, No. 5, May 1990), discloses an inverse filter technique to reverse the effects of camera motion and correct for blur in a captured image based on estimated camera motion parameters. During this technique, the inverse of a motion blur filter that is constructed according to estimated camera motion parameters is applied directly to the blurred image.

Unfortunately, the Biemond et al. blur correction technique suffers disadvantages. Convolving the blurred image with the inverse of the motion blur filter can lead to excessive noise amplification. Furthermore, with reference to the restoration equation disclosed by Biemond et al., the error contributing term, which has positive spikes at integer multiples of the blurring distance, is amplified when convolved with high contrast structures such as edges in the blurred image, leading to undesirable ringing. Ringing is the appearance of haloes and/or rings near sharp edges in the image and is associated with the fact that de-blurring an image is an ill-conditioned inverse problem. The Biemond et al. publication discusses reducing the ringing effect based on the local edge content of the image, so as to regulate the edgy regions less strongly and suppress noise amplification in regions that are sufficiently smooth. However, with this approach, ringing noise may still remain in local regions containing edges.

Other blur correction techniques making use of an inverse filter have been considered. For example, U.S. Pat. No. 6,166,384 to Dentinger et al. discloses a method and apparatus for minimizing blurring of an image in a radiation imaging system. Noise is suppressed at frequencies where the signal-to-noise ratio (SNR) is low, in order to generate a high resolution signal. An analysis module employs a filter having a frequency response which controls inverse filtering and noise regularization using a single parameter, such that the noise regularization decreases the frequency response of the filter as the frequency of the signal increases. More particularly, the filter comprises an inverse filtering portion and a noise regularization portion which are controlled by the single parameter. It is assumed that the noise and signal spectra are not accurately known. The blurring is modelled as a linear shift-invariant process and can be expressed as a convolution of the original image with a known blurring function. The regularization portion of the filter decreases the response of the filter as the frequency increases to prevent noise enhancement in the low signal-to-noise ratio regions.

Various techniques that use an iterative approach to generate blur corrected images have also been proposed. Typically during these iterative techniques, a guess image is motion blurred using the estimated camera motion parameters and the guess image is updated based on the differences between the motion blurred guess image and the captured blurred image. This process is performed iteratively a predetermined number of times or until the guess image is sufficiently blur corrected. Because the camera motion parameters are estimated, blur in the guess image is reduced during the iterative process as the error between the motion blurred guess image and the captured blurred image decreases to zero. The above iterative problem can be formulated according to Equation (1) as follows:

I(x,y)=h(x,y) [symbol] O(x,y)+n(x,y) (1)

where:

I(x,y) is the captured motion blurred image;

h(x,y) is the motion blurring function;

O(x,y) is an unblurred image corresponding to the motion blurred image I(x,y);

n(x,y) is noise; and

A [symbol] B denotes the convolution of A and B.

As will be appreciated from the above, the goal of image blur correction is to produce an estimate (restored) image O′(x,y) of the unblurred image, O(x,y), given the captured blurred image, I(x,y). In Equation (1), the motion blurring function h(x,y) is assumed to be known from the estimated camera motion parameters. If noise is ignored, the error E(x,y) between the restored image, O′(x,y), and the unblurred image, O(x,y), can be defined by Equation (2) as follows:

E(x,y)=I(x,y)−h(x,y) [symbol] O′(x,y) (2)

While iterative motion blur correction procedures provide improvements, excessive ringing and noise can still be problematic. These problems are due in part to the ill-conditioned nature of the motion blur correction problem, but are also due to motion blur parameter estimation errors and noise amplification during deconvolution. Furthermore, because in any practical implementation the number of corrective iterations is limited due to performance concerns, convergence to an acceptable solution is often difficult to achieve.

Other iterative blur correction methods as well as wavelet decomposition blur correction methods have also been proposed. For example, U.S. Pat. No. 5,526,446 to Adelson et al. discloses a noise reduction system that reduces noise content and sharpens an input image by transforming the input image into a set of transform coefficients in a multi-scale image decomposition process. Each transform coefficient is modified based on its value and the value of transform coefficients of related orientation, position or scale. A reconstruction process generates the enhanced image. Enhancement takes into account related transform coefficients and local orientation for permitting appropriate modification of each transform coefficient. A transform coefficient is related when it is (x, y) displaced from the transform coefficient to be modified, is of a different scale, or is of a different orientation. Each transform coefficient is modified based on statistical properties of the input image obtained during an analysis phase. During the analysis phase, the input image is artificially degraded by adding noise and/or blurring it and/or reducing its spatial resolution. Transform coefficients of the degraded and undegraded images are then compared over many positions, scales and orientations in order to estimate the corresponding transform coefficients.

U.S. Patent Application Publication No. 2003/0086623 to Berkner et al. discloses a method and apparatus for enhancing compressed images by removing quantization artifacts and via deblurring, using wavelet sharpening and smoothing to obtain quantized coefficients. Actual noise filtering in the wavelet domain is conducted by either hard-thresholding or soft-thresholding the coefficients, and then modifying the thresholded coefficients in order to either sharpen or smooth the image. In one embodiment, sharpening or smoothing is conducted by multiplying the wavelet coefficients with a level-dependent parameter. Information on the quantization scheme used during encoding and the inverse wavelet transforms used is employed in order to first characterize, and then remove the quantization noise on each Low-Low (LL) component computed during reconstruction using the inverse wavelet transform.

U.S. Patent Application Publication No. 2003/0202713 to Sowa discloses a digital image enhancement method for enhancing a digital image bearing artifacts of compression. The method relies on known discrete Cosine transformed (i.e. JPEG or MPEG) compression schemes, with known parameters of quantization employed during compression. Transform coefficients are computed by applying a transform to the digital image. A filter is then applied to the transform coefficients. Upon inverse-transforming based on the filtered transform coefficients of the image, the actual parameters from quantization are used to form a constraint matrix. The procedure is repeated iteratively a predetermined number of times in order to provide an enhanced output image.

U.S. Patent Application Publication No. 2004/0247196 to Chanas et al. discloses a method for correcting for blur in a digital image by calculating a transformed image that is corrected for all or part of the blurring. The method includes selecting image zones to be corrected and constructing, for each image zone to be corrected, an enhancement profile based on formatted information and on characteristic noise data. Correction is performed by obtaining transformed image zones as a function of the enhancement profile of each image zone and combining the transformed image zones to obtain the transformed image.

U.S. Patent Application Publication No. 2004/0268096 to Master et al. discloses a method for reducing blurring in a digital image. The image is linearly filtered using low-pass filters to suppress high-frequency noise, and non-linearly filtered using morphologic and median filters to reduce distortion in the image. Multi-rate filter banks are then used to perform wavelet-based distortion reduction. During wavelet-based distortion reduction, a discrete wavelet transform compacts image energy into a small number of discrete wavelet transform coefficients having large amplitudes. The energy of the noise is spread over a large number of the discrete wavelet transform coefficients having small amplitudes, and the noise and other distortions are removed using an adjustable threshold filter.

U.S. Patent Application Publication Nos. 2005/0074065 and 2005/0094731 to Xu et al. disclose a video encoding system that uses a three dimensional wavelet transform. The wavelet transform supports object-based encoding for reducing the encoding system's sensitivity to motion and thereby remove the motion blur in the resulting video playback. The three dimensional wavelet transform uses motion trajectories in the temporal direction to obtain more efficient wavelet decomposition and to reduce or remove the motion blurring artifacts for low bit-rate coding.

U.S. Patent Application Publication No. 2005/0074152 to Lewin et al. discloses a method of reconstructing a magnetic resonance image from non-rectilinearly-sampled k-space data. During the method, sampled k-space data is distributed on a rectilinear k-space grid and an inverse Fourier transform is applied to the distributed data. A selected portion of the inverse-transformed data is set to zero and then the zeroed and remaining portions of the inverse-transformed data are forward transformed at grid points associated with the selected portion. The transformed data is replaced with the distributed k-space data to produce a grid of updated data and the updated data is then inverse transformed. These steps are iterated until a difference between the updated inverse-transformed data and the inverse transformed distributed data is sufficiently small.

U.S. Patent Application Publication No. 2005/0147313 to Gorinevsky discloses an iterative method for deblurring an image using a systolic array processor. Data is sequentially exchanged between processing logic blocks by interconnecting each processing logic block with a predefined number of adjacent processing logic blocks, followed by uploading the deblurred image. The processing logic blocks provide an iterative update of the blurred image through feedback of the blurred image prediction error using the deblurred image and feedback of the past deblurred image estimate. Image updates are thereby generated iteratively.

U.S. Patent Application Publication No. 2006/0013479 to Trimeche et al. discloses a method for restoring color components in an image model. A blur degradation function is determined by measuring a point-spread function and employing pseudo-inverse filtering during which a frequency low-pass filter is used to limit the noise. Several images are processed in order to obtain an average estimate of the point-spread function. The energy between the input and simulated re-blurred image is iteratively minimized and a smoothing operation is conducted by including a regularization term which consists of a high-pass filtered version of the output.

While iterative and wavelet decomposition methods such as those described above provide some advantages over direct reversal of blur using motion blur filters, it will be appreciated that improvements are desired for reducing noise amplification and ringing. It is therefore an object of the present invention to provide a novel method and apparatus for reducing motion blur in an image.

### SUMMARY OF THE INVENTION

In accordance with one aspect, there is provided a method of reducing motion blur in a motion blurred image comprising:

blurring a guess image based on said motion blurred image as a function of blur parameters of the motion blurred image;

comparing the blurred guess image with the motion blurred image and generating an error image;

blurring the error image;

forming a regularization image based on edges in the guess image; and

combining the error image, the regularization image and the guess image thereby to update the guess image and correct for motion blur.

In one embodiment, the regularization image forming comprises constructing horizontal and vertical edge images from the guess image and summing the horizontal and vertical edge images thereby to form the regularization image. Weighting of the horizontal and vertical edge images may be conducted during the summing. The weighting may be based on an estimate of the motion blur direction. The horizontal and vertical edge images may be normalized prior to summing.

If desired, the updated guess image may be noise filtered. During noise filtering, a wavelet decomposition of the updated guess image is conducted and a noise variance in a highest frequency scale of the wavelet decomposition is calculated. The coefficient values of the wavelet decomposition are adjusted based on the calculated noise variance and a noise filtered update guess image is constructed based on the adjusted coefficient values. The guess image blurring, comparing, error image blurring, forming and combining may be performed iteratively.

According to another aspect, there is provided a method of generating a motion blur reduced image using multiple motion blurred images each having respective blur parameters comprising:

establishing a guess image based on the motion blurred images;

forming multiple blurred guess images from the guess image as a function of the respective blur parameters;

comparing each blurred guess image with a respective one of the motion blurred images and generating respective error images;

blurring the error images as a function of the estimated blur direction and respective ones of the blur extents;

forming a regularization image based on edges in the guess image; and

combining the error images, the regularization image and the guess image thereby to update the guess image and correct for motion blur.

In one embodiment, the establishing comprises averaging the motion blurred images. The combining comprises weighting and combining the error images. The weighting of each error image may be based on the motion blur extent estimated in the motion blurred image corresponding to the error image and the weighting may be nonlinearly distributed amongst the error images.

According to another aspect, there is provided an apparatus for reducing motion blur in a motion blurred image, the apparatus comprising:

a guess image blurring module blurring a guess image based on the motion blurred image as a function of the blur parameters of the motion blurred image;

a comparator comparing the blurred guess image with the motion blurred image and generating an error image;

an error image blurring module blurring the error image;

a regularization module forming a regularization image based on edges in the guess image; and

an image combiner combining the error image, the regularization image and the guess image thereby to update the guess image and correct for motion blur.

According to another aspect, there is provided an apparatus for generating a motion blur reduced image using multiple motion blurred images each having respective blur parameters, the apparatus comprising:

a guess image generator establishing a guess image based on the motion blurred images;

a guess image blurring module forming multiple blurred guess images from the guess image as a function of the respective blur parameters;

a comparator comparing each blurred guess image with a respective one of the motion blurred images and generating respective error images;

an error image blurring module blurring the error images as a function of the estimated blur direction and respective ones of the blur extents;

a regularization module forming a regularization image based on edges in the guess image; and

an image combiner combining the error images, the regularization image and the guess image thereby to update the guess image and correct for motion blur.

According to another aspect, there is provided a computer readable medium embodying a computer program for reducing motion blur in a motion blurred image, the computer program comprising:

computer program code blurring a guess image based on said motion blurred image as a function of blur parameters of the motion blurred image;

computer program code comparing the blurred guess image with the motion blurred image and generating an error image;

computer program code blurring the error image;

computer program code forming a regularization image based on edges in the guess image; and

computer program code combining the error image, the regularization image and the guess image thereby to update the guess image and correct for motion blur.

According to another aspect, there is provided a computer readable medium embodying a computer program for generating a motion blur reduced image using multiple motion blurred images each having respective blur parameters, the computer program comprising:

computer program code establishing a guess image based on the motion blurred images;

computer program code forming multiple blurred guess images from the guess image as a function of the respective blur parameters;

computer program code comparing each blurred guess image with a respective one of the motion blurred images and generating respective error images;

computer program code blurring the error images as a function of the estimated blur direction and respective ones of the blur extents;

computer program code forming a regularization image based on edges in the guess image; and

computer program code combining the error images, the regularization image and the guess image thereby to update the guess image and correct for motion blur.

The blur reducing method and apparatus provide several advantages. In particular, the addition of a regularization term suppresses noise amplification during deconvolution, and reduces ringing artifacts. In the case of linear constant-velocity motion, the weighting of horizontal and vertical edges in the regularization term is based on the determined direction of motion blur, thereby reducing undesirable blurring of edges in non-motion directions during blur correction. Generating a motion blur corrected output image using multiple motion blurred images provides improved motion blur correction results when compared with known methods that blur-correct a single-image.

### BRIEF DESCRIPTION OF THE DRAWINGS

Embodiments will now be described more fully with reference to the accompanying drawings, in which:

FIG. 1 is a flowchart showing steps for capturing a motion blurred image, estimating the motion blur extent and motion blur direction in the captured image, and correcting for motion blur in the captured image;

FIG. 2 is a flowchart better illustrating the steps for correcting motion blur in a captured image using the estimates of motion blur extent and motion blur direction;

FIG. 3 is a flowchart showing steps for capturing multiple motion blurred images, estimating the blur direction and blur extent for each captured image, and generating a blur-corrected output image using the captured images; and

FIG. 4 is a flowchart better illustrating the steps for forming a blur-corrected output image using multiple captured images.

### DETAILED DESCRIPTION OF THE EMBODIMENTS

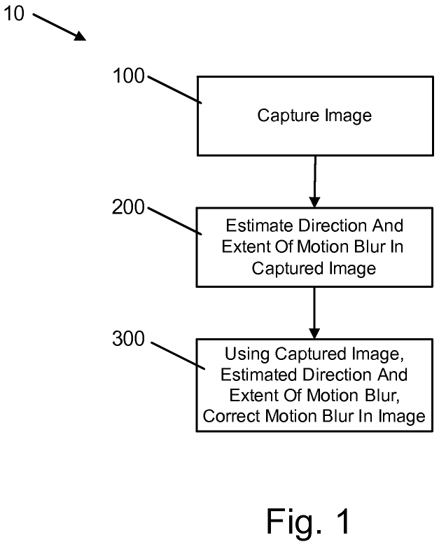

In the following description, methods, apparatuses and computer readable media embodying computer programs for reducing motion blur in an image are disclosed. The methods and apparatuses may be embodied in a software application comprising computer executable instructions executed by a processing unit including but not limited to a personal computer, a digital image or video capture device such as for example a digital camera, camcorder or electronic device with video capabilities, or other computing system environment. The software application may run as a stand-alone digital video tool, an embedded function or may be incorporated into other available digital image/video applications to provide enhanced functionality to those digital image/video applications. The software application may comprise program modules including routines, programs, object components, data structures etc. and may be embodied as computer readable program code stored on a computer readable medium. The computer readable medium is any data storage device that can store data, which can thereafter be read by a computer system. Examples of computer readable media include for example read-only memory, random-access memory, CD-ROMs, magnetic tape and optical data storage devices. The computer readable program code can also be distributed over a network including coupled computer systems so that the computer readable program code is stored and executed in a distributed fashion. Embodiments will now be described with reference to FIGS. 1 to 4.

Turning now to FIG. 1, a method of reducing motion blur in an image captured by an image capture device such as for example, a digital camera, digital video camera or the like is shown. During the method, when a motion blurred image is captured (step 100) its Y-channel luminance image is extracted and the direction and extent of motion blur in the captured image is estimated (step 200). The estimated motion blur parameters (i.e. the estimated blur direction and blur extent) are then used to reduce motion blur in the captured image (step 400) thereby to generate a motion blur corrected image.

The motion blur parameters may be estimated using well-known techniques. For example, input data from a gyro-based system in the image capture device may be obtained during exposure and processed to calculate an estimate of the motion blur direction and motion blur extent. Alternatively, blind motion estimation using attributes inherent to the captured motion blurred image may be used to obtain the motion blur direction and motion blur extent, as described in aforementioned U.S. patent application Ser. No. 10/827,394, for example, the content of which has been incorporated herein by reference.

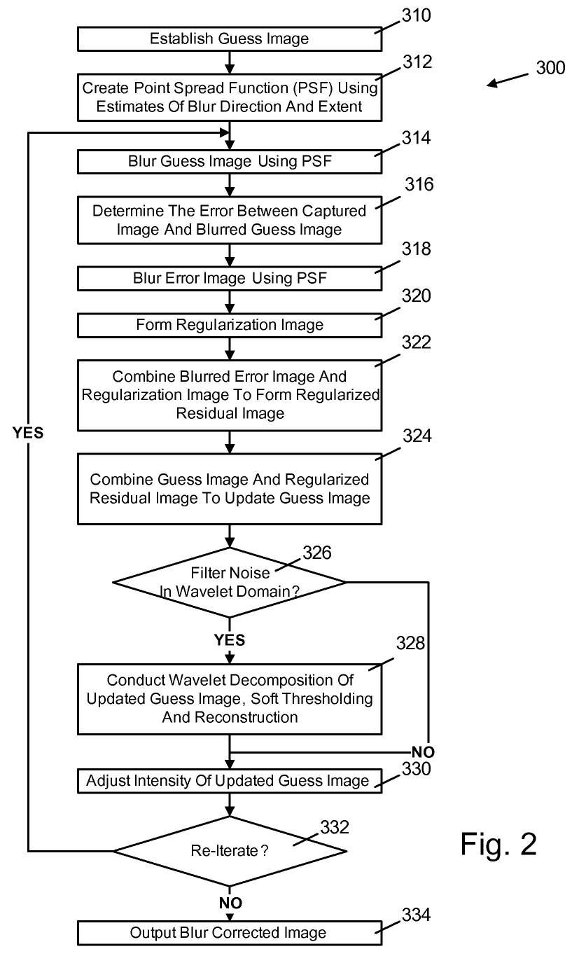

FIG. 2 is a flowchart showing the steps performed during generation of the motion blur corrected image using the estimated motion blur direction and blur extent of the captured image (step 300). Initially, an initial guess image O₀(x,y) equal to the captured image I(x,y) is established (step 310), as expressed by Equation (3) below:

Oₙ(x,y)=I(x,y) (3)

where:

n is the iteration count, in this case zero (0).

A point spread function (PSF) or “motion blur filter” is then created based on the estimated blur direction and blur extent (step 312). Methods for creating a point spread function where motion during image capture is assumed to have occurred linearly and at a constant velocity are well-known, and will not be described in further detail herein. Following creation of the PSF, the guess image is then blurred using the PSF (step 314) and an error image is calculated by finding the difference between the blurred guess image and the captured input image (step 316). The error image is then convolved with the PSF to form a blurred error image (step 318). A regularization image is then formed (step 320).

During formation of the regularization image, a regularization term is obtained by calculating horizontal and vertical edge images Oₕ and Oᵥ respectively, based on the guess image Oₙ₋₁, as expressed by Equations (4) and (5) below:

Oₕ=Oₙ₋₁ [symbol] D*^{T} (4)

Oᵥ=Oₙ₋₁ [symbol] D* (5)

where:

$$D = \frac{1}{4} [ \begin{matrix}- 1 & - 2 & - 1 \\ 0 & 0 & 0 \\ 1 & 2 & 1\end{matrix} ] ,$$

a Sobel derivative operator; and

D*(x, y)=D(−x, −y).

The Sobel derivative operator referred to above is a known high-pass filter suitable for use in determining the edge response of an image.

The horizontal and vertical edge images Oₕ and Oᵥ are then normalized. To achieve p-norm regularization and thereby control the extent of sharpening or smoothing, the manner of normalizing is selectable. In particular, a variable p having a value between one (1) and two (2) is selected and then used for calculating the normalized horizontal and vertical edge images according to the following routine:

If p not = 2

If p = 1

${O}_{h} ( x , y ) = \frac{{O}_{h} ( x , y )}{\vert {O}_{h} ( x , y ) \vert + \vert {O}_{v} ( x , y ) \vert}$
${O}_{v} ( x , y ) = \frac{{O}_{v} ( x , y )}{\vert {O}_{h} ( x , y ) \vert + \vert {O}_{v} ( x , y ) \vert}$

Else

${O}_{h} ( x , y ) = \frac{{pO}_{h} ( x , y )}{{\vert {O}_{h} ( x , y ) \vert}^{2 - p} + {\vert {O}_{v} ( x , y ) \vert}^{2 - p}}$
${O}_{v} ( x , y ) = \frac{{pO}_{v} ( x , y )}{{\vert {O}_{h} ( x , y ) \vert}^{2 - p} + {\vert {O}_{v} ( x , y ) \vert}^{2 - p}}$

End If

End If

It will be understood that a p value equal to 1 results in a normalization consistent with total variation regularization, whereas a p value equal to 2 results in a normalization consistent with Tikhonov-Miller regularization. A p-value between one (1) and two (2) results in a regularization strength between those of total variation regularization and Tikhonov-Miller regularization, which, in some cases, helps to avoid over-sharp or over-smooth results. The p value may be user selectable or set to a default value.

Where blur parameter estimation has been undertaken with the assumption that motion of the image capture device during image capture was linear and at a constant velocity, the normalized horizontal and vertical edge images Oₕ and Oᵥ are then weighted according to the estimated linear direction of motion blur, and summed to form an orientation-selective regularization image L, as expressed by Equation (6) below:

L=cos(θₘ)·(Oₕ [symbol] D^{T})+sin(θₘ)·(Oᵥ\textcircled{×}D) (6)

Where blur parameter estimation has taken into account that motion of the image capture device during image capture may not have been linear and at a constant velocity, the regularization image L is not weighted according to an estimated linear direction of motion blur. Rather, the regularization image L is formed without the directional weighting, as expressed by Equation (7) below:

L=(Oₕ [symbol] D^{T})+(Oᵥ [symbol] D) (7)

Regularization image L and the blurred error image are then combined to form a regularized residual image R (step 322), as expressed by Equation (8) below:

R=h* [symbol] (I−Oₙ₋₁ [symbol] h)−ηL (8)

where:

h*(x,y)=h(−x,−y); and

η is the regularization parameter.

It will be understood that the regularization parameter η is selected based on an amount of regularization that is desired to sufficiently reduce ringing artifacts in an updated guess image. Following formation of the regularized residual image R at step 322, the regularized residual image R and the guess image Oₙ₋₁ are combined thereby to obtain an updated guess image Oₙ (step 324), according to Equation (9) below:

Oₙ=Oₙ₋₁+α·R (9)

where:

α Is the iteration step size.

It will be understood that the iteration step size α is selected based on the amount of correction desired at each iteration, and will depend in part on the number of iterations to be carried out during the motion blur correction process.

With the updated guess image Oₙ having been generated, it is then determined whether noise filtering in the wavelet domain is to be conducted during the current iteration (step 326). This is achieved by checking the value of a filtering parameter. The filtering parameter in this embodiment is a user preference setting permitting control over performance by enabling the user to establish whether, and how often, noise filtering is to be performed. For example, the filtering parameter could have a value equal to zero (0), in which case no noise filtering is performed. Alternatively, the filtering parameter could have a value equal to one (1), in which case noise filtering is performed during every iteration. In yet another alternative, the filtering parameter could have a value equal to two (2), in which case noise filtering is performed every second iteration, and so on. Of course, if desired, the filtering parameter may be set to a default value.

If noise filtering in the wavelet domain is to be conducted during the current iteration, a J-level redundant wavelet decomposition of the updated guess image Oₙ is computed (step 328), according to Equation (10) below:

$${O}_{n} = {C}_{J} + {\sum }_{j = 1}^{J} {W}_{j} \qquad ( 10 )$$

The initial value of noise variance σ is then calculated using the coefficients of the finest scale of the decomposition W₁(x, y) (i.e., the highest frequencies), according to Equations (11) to (13) below:

$$\begin{matrix}{σ}_{0} = \frac{med \{ \vert {W}_{1} ( x , y ) \vert \}}{0.6745} & ( 11 ) \\ {σ}_{n} = \frac{med \{ \vert {W}_{1} ( x , y ) \vert \}}{0.6745} & ( 12 ) \\ {σ}_{n} = max ( {σ}_{n} , {σ}_{0} ) & ( 13 )\end{matrix}$$

where:

med { } is the median function returning the middle value of the decomposition W₁(x, y).

Using the calculated noise variance σ, local soft thresholding is applied to the wavelet coefficients of Wⱼ(x, y) according to Equation (14) below:

$${W}_{j} ( x , y ) = {m}_{j} + sign ( {W}_{j} ( x , y ) - {m}_{j} ) \cdot Tr ( \vert {W}_{j} ( x , y ) - {m}_{j} \vert - \frac{\sqrt{2} {σ}_{n}^{2}}{{σ}_{j}^{2}} ) \qquad ( 14 )$$

where:

mⱼ is the local mean at location (x, y);

σⱼ is the local variance at location (x, y); and

$$Tr ( x ) = \{ \begin{matrix}x ; x > 0 \\ 0 ; otherwise\end{matrix}$$

A locally weighted Weiner filter is then applied to C_{J}(x, y), the LL band of the wavelet decomposition, according to Equation (15) below:

$${C}_{J} ( x , y ) = {m}_{j} + \frac{{σ}_{J}^{2}}{{σ}_{J}^{2} + {σ}_{n}^{2}} ( {C}_{J} ( x , y ) - {m}_{J} ) \qquad ( 15 )$$

The updated guess image Oₙ is then reconstructed from the soft-thresholded wavelet coefficients of Wⱼ(x, y) and the Weiner filtered LL band C_{J}(x, y).

The intensities of the pixels in the updated guess image Oₙ are then adjusted as necessary to fall between 0 and 255, inclusive (step 330), according to Equation (16) below:

$${O}_{n} ( x , y ) = \{ \begin{matrix}0 ; {O}_{n} ( x , y ) < 0 \\ 255 ; {O}_{n} ( x , y ) > 255 \\ {O}_{n} ( x , y ) ; otherwise\end{matrix} \qquad ( 16 )$$

After the intensities of the pixels have been adjusted as necessary, it is then determined at step 332 whether to output the updated guess image Oₙ as the motion blur corrected image, or to revert back to step 314. The decision as to whether to continue iterating in this embodiment, is based on the number of iterations having exceeded a threshold number. If no more iterations are to be conducted, then the updated guess image Oₙ is output as the motion blur corrected image (step 334).

As will be appreciated, the blur correction method including p-norm regularization and noise filtering in the wavelet domain can be computationally complex and therefore expensive. To enhance performance (i.e., speed), in some instances noise filtering in the wavelet domain may be skipped during some iterations omitted entirely. The decision to skip or omit noise filtering in the wavelet domain in this embodiment is based on the filtering parameter. Of course skipping or omitting noise filtering results in a trade-off between the overall speed of motion blur correction and the amount of desired/required noise removal. For example, where the input image has a high signal-to-noise ratio (i.e. 30 dB or greater, for example), there may be no need to perform any wavelet domain noise filtering.

Furthermore, in some implementations it may be advantageous to limit the p-norm p value to 1. While performance (i.e., speed) is increased as a result, only in relatively rare cases is motion blur correction quality significantly degraded. For example, by completely disabling noise filtering in the wavelet domain and setting a p-norm p value equal to one (1), during one iteration only four (4) convolutions of an image with one 3×3 mask (i.e., the Sobel derivative operator), and two (2) convolutions of images with the PSF (i.e., the blurring of the guess image and the blurring of the error image) are conducted.

In the case of linear, constant-velocity motion, regularization is based on motion blur direction. Therefore, unnecessary correction and overcorrection is reduced. Depending on the amount of high-contrast data in the input image, ringing due to error during convolution with high contrast image structures is therefore reduced because the amount of regularization is tuned to the estimated motion blur direction. Advantageously, reduction of ringing is complementary to the task of motion blur correction, because edges progressively parallel to the direction of motion require progressively less and less motion blur correction.

It will be understood that while the steps 314 to 330 are described as being executed a threshold number of times, other criteria for limiting the number of iterations may be used in concert or as alternatives. For example, the iteration process may proceed until the magnitude of the error between the captured image and the blurred guess image falls below a threshold level, or fails to change in a subsequent iteration by more than a threshold amount. The number of iterations may alternatively be based on other equally-indicative criteria.

It is also possible that noise filtering in the wavelet domain may be performed during an iteration only if the signal-to-noise ratio of an updated guess image is greater than a threshold level.

It will be apparent to one of ordinary skill in the art that as alternatives to the Sobel derivative operator for obtaining the horizontal and vertical edge images, other suitable edge detectors/high-pass filters may be employed.

The method for reducing motion blur in a captured image may be applied more generally to the task of generating a blur corrected output image using multiple motion-blurred images of the same scene. In the publication entitled “Two Motion-Blurred Images Are Better Than One”, authored by Alex Rav-Acha and Shmuel Peleg (Pattern Recognition Letters, Vol. 26, pp. 311-317, 2005), it was shown that there can be advantages to processing multiple motion-blurred images of the same scene each having different motion blur directions to obtain a motion blur corrected image.

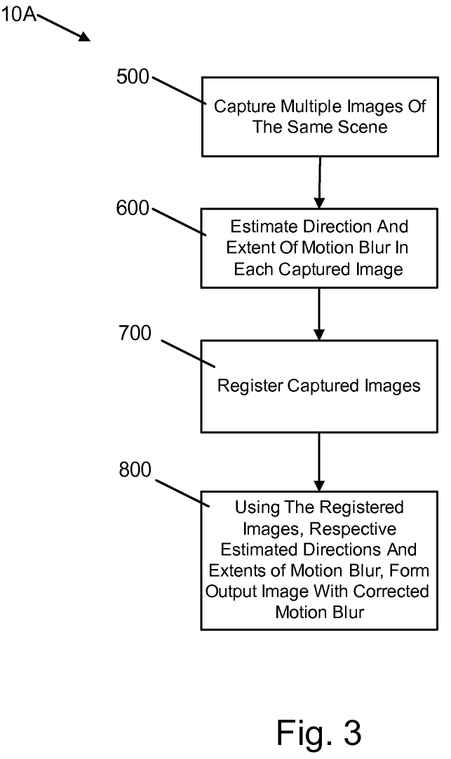

Turning now to FIG. 3, a method of generating a blur-corrected output image using multiple images captured by an image capture device such as for example, a digital camera, digital video camera or the like is shown. During the method, when motion blurred images of the same scene are captured (step 500), the direction and extent of motion blur in each captured image is estimated (step 600). In order to correctly register features in the captured images for motion blur correction, and because correspondence between the captured images is “fuzzy” due to each of the captured images having been blurred by a respective motion blur extent, the captured motion blurred images are then registered with each other (step 700). Known Matlab image alignment algorithms may be employed to achieve image registration under these conditions.

Once the captured images are registered, their estimated motion blur parameters (i.e. the estimated blur direction and respective blur extents) are then used to generate a motion blur corrected output image with reduced motion blur (step 800).

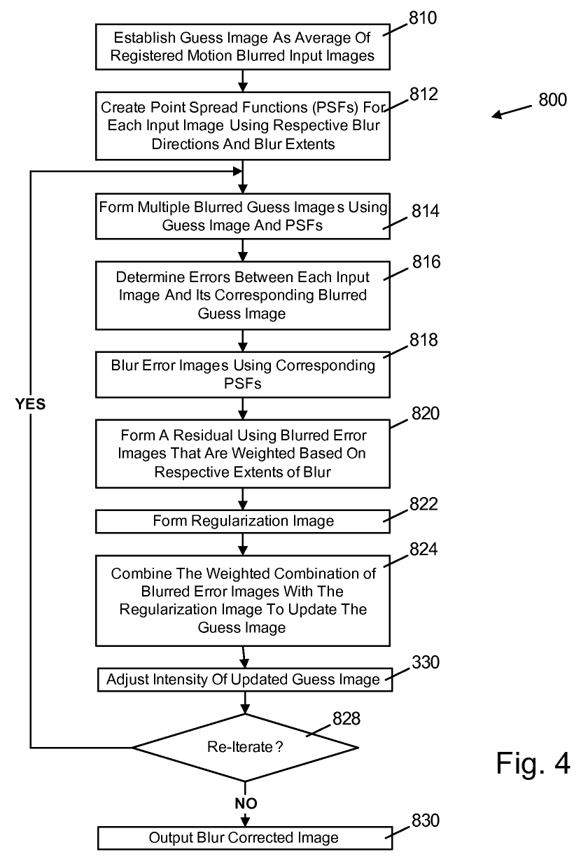

The steps performed to generate the motion blur corrected output image at step 800, are better illustrated in FIG. 4. First, a guess image O₀ is established as an average of the registered images Iₘ (step 810), according to Equation (17) below:

$${O}_{0} ( x , y ) = \frac{1}{M} {\sum }_{m = 1}^{M} {I}_{m} ( x , y ) \qquad ( 17 )$$

A point spread function (PSF) for each registered image Iₘ is then created based on the respective estimations of motion blur direction and blur extent in each registered image (step 812). Following creation of the PSFs, multiple blurred guess images are formed by blurring the guess image O₀ with each of the PSFs (step 814). Error images are then formed as the differences between the blurred guess images and a respective registered image (step 816). Each error image is then blurred by convolving the error image with a corresponding PSF (step 818) to form a respective blurred error image. A weighted residual image R is then formed by weighting and summing the blurred error images. The weighting is based on a respective extent of blur in its corresponding registered image (step 820), and is expressed by Equation (18) below:

$$R = {\sum }_{m = 1}^{M} {w}_{m} \cdot ( {h}_{m} * ⊗ ( {I}_{m} - {O}_{n - 1} ⊗ {h}_{m} ) ) \qquad ( 18 )$$

where:

$${w}_{m} = \frac{{l}_{m}^{- q}}{{\sum }_{m = 1}^{M} {l}_{m}^{- q}} ;$$

lₘ is the estimated extent of blur in registered image m;

q is a parameter for adjusting for the nonlinearity of the weighted contribution of the m registered images; and

h*(x,y)=h(−x,−y).

With the weighted residual image R having been formed, a regularization image L is then formed (step 822) by calculating horizontal and vertical edge images Oₕ and Oᵥ respectively, based on the guess image and normalizing the horizontal and vertical edge images using a p-norm value of p=1, as described above. The normalized horizontal and vertical edge images Oₕ and Oᵥ are then combined according to Equation (7).

Regularization image L, weighted residual image R and the guess image are then combined to form an updated guess image Oₙ (step 824) according to Equation (19) below:

Oₙ=Oₙ₋₁+α(R−ηL) (19)

where:

α is the iteration step size; and

η is the regularization parameter.

The intensities of the pixels in the updated guess image Oₙ are then adjusted as necessary to fall between 0 and 255, inclusive (step 330), according to Equation 16.

After the intensities of the pixels of the updated guess image have been adjusted as necessary, it is then determined at step 828 whether to output the updated guess image Oₙ as the motion blur corrected image, or to revert back to step 814. The decision as to whether to continue iterating is based on the number of iterations having exceeded a threshold number. Alternative criteria may be employed as described above. If no more iterations are to be conducted, then the updated guess image Oₙ is output as the motion blur corrected image (step 830).

It can been seen that the method for correcting for motion blur using multiple captured images is similar to the method for correcting for motion blur using a single captured image, where the p-norm p value is set to one (1) and there is no filtering of noise in the wavelet domain. However, it will be understood that during motion blur correction using multiple captured images, different p-norm values may be employed, and noise filtering in the wavelet domain may be conducted if the resulting processing costs are acceptable.

It is known that in order to simplify motion blur correction, blur-causing motion is typically assumed to be linear and at a constant velocity. However, because motion blur correction depends heavily on an initial estimation of motion blur extent and direction, inaccurate estimations of motion blur extent and direction can result in unsatisfactory motion blur correction results. Advantageously, the above-described methods may be used with a point spread function (PSF) that represents more complex image capture device motion. In such cases, it should be noted that the orientation-selective regularization image expressed by Equation (6) is best suited to situations of linear, constant-velocity motion. In complex motion situations, a regularization image such as that expressed by Equation (7) should be employed.

Although particular embodiments of the invention have been described above, those of skill in the art will appreciate that variations and modifications may be made without departing from the spirit and scope thereof as defined by the appended claims.

What is claimed is:

1. A method of reducing motion blur in a motion blurred image comprising:
blurring a guess image based on said motion blurred image as a function of blur parameters of the motion blurred image;
comparing the blurred guess image with the motion blurred image and generating an error image;
blurring the error image;
forming a regularization image based on edges in the guess image; and
combining the error image, the regularization image and the guess image thereby to update the guess image and correct for motion blur.

2. The method of claim 1, wherein the regularization image forming comprises:
constructing horizontal and vertical edge images from the guess image; and
summing the horizontal and vertical edge images thereby to form the regularization image.

3. The method of claim 2, comprising:
weighting the horizontal and vertical edge images during the summing.

4. The method of claim 3, wherein the weighting is based on an estimate of motion blur direction.

5. The method of claim 2, comprising:
normalizing the horizontal and vertical edge images prior to the summing.

6. The method of claim 2, comprising:
normalizing the horizontal and vertical edge images for total variation regularization.

7. The method of claim 2, comprising:
normalizing the horizontal and vertical edge images for Tikhonov-Miller regularization.

8. The method of claim 1 wherein said guess image is the motion blurred image.

9. The method of claim 1, further comprising:
noise filtering the updated guess image.

10. The method of claim 9, wherein the noise filtering comprises:
conducting a wavelet decomposition of the updated guess image;
calculating a noise variance in a highest frequency scale of the wavelet decomposition;
adjusting coefficient values of the wavelet decomposition based on the calculated noise variance; and
constructing a noise filtered updated guess image based on the adjusted coefficient values.

11. The method of claim 9 wherein the guess image blurring, comparing, error image blurring, forming, combining and noise filtering are performed iteratively.

12. The method of claim 11 wherein the guess image blurring, comparing, error image blurring, forming, combining and noise filtering are performed iteratively a threshold number of times.

13. The method of claim 12 wherein the noise filtering is performed every iteration.

14. The method of claim 12 wherein the noise filtering is skipped during at least one iteration.

15. A method of generating a motion blur reduced image using multiple motion blurred images each having respective blur parameters comprising:
establishing a guess image based on the motion blurred images;
forming multiple blurred guess images from the guess image as a function of the respective blur parameters;
comparing each blurred guess image with a respective one of the motion blurred images and generating respective error images;
blurring the error images as a function of the estimated blur direction and respective ones of the blur extents;
forming a regularization image based on edges in the guess image; and
combining the error images, the regularization image and the guess image thereby to update the guess image and correct for motion blur.

16. The method of claim 15, wherein the establishing comprises:
averaging the motion blurred images to establish the guess image.

17. The method of claim 15, wherein the combining comprises:
weighting and combining the error images.

18. The method of claim 17 wherein weighting of each error image is based on the motion blur extent estimated in the motion blurred image corresponding to the error image.

19. The method of claim 18 wherein the weighting is nonlinearly distributed amongst the error images.

20. The method of claim 15, wherein the forming multiple blurred guess images, comparing, blurring, forming a regularization image and combining are performed iteratively.

21. The method of claim 20 wherein the forming multiple blurred guess images, comparing, blurring, forming a regularization image and combining are performed iteratively a threshold number of times.

22. The method of claim 16, wherein the establishing further comprises registering the multiple motion blurred images prior to said averaging.

23. The method of claim 22, wherein the multiple motion blurred images share the same blur direction.

24. An apparatus for reducing motion blur in a motion blurred image, the apparatus comprising:
a guess image blurring module blurring a guess image based on the motion blurred image as a function of the blur parameters of the motion blurred image;
a comparator comparing the blurred guess image with the motion blurred image and generating an error image;
an error image blurring module blurring the error image;
a regularization module forming a regularization image based on edges in the guess image; and
an image combiner combining the error image, the regularization image and the guess image thereby to update the guess image and correct for motion blur.

25. The apparatus of claim 24, further comprising:
a noise filter filtering noise from the updated guess image.

26. The apparatus of claim 25, wherein the noise filter comprises:
a decomposer conducting a wavelet decomposition of the updated guess image;
a calculator calculating a noise variance in a highest frequency scale of the wavelet decomposition;
a thresholder adjusting coefficient values of the wavelet decomposition based on the calculated noise variance; and
a constructor constructing a noise filtered updated guess image based on the adjusted coefficient values.

27. The apparatus of claim 25 wherein the guess image blurring, comparing, error image blurring, forming, combining and filtering are performed iteratively.

28. An apparatus for generating a motion blur reduced image using multiple motion blurred images each having respective blur parameters, the apparatus comprising:
a guess image generator establishing a guess image based on the motion blurred images;
a guess image blurring module forming multiple blurred guess images from the guess image as a function of the respective blur parameters;
a comparator comparing each blurred guess image with a respective one of the motion blurred images and generating respective error images;
an error image blurring module blurring the error images as a function of the estimated blur direction and respective ones of the blur extents;
a regularization module forming a regularization image based on edges in the guess image; and
an image combiner combining the error images, the regularization image and the guess image thereby to update the guess image and correct for motion blur.

29. The apparatus of claim 28, wherein the guess image generator averages the motion blurred images to establish the guess image.

30. The apparatus of claim 28, wherein the forming multiple blurred guess images, comparing, blurring, forming a regularization image and combining are performed iteratively.
